(19) United States
(12) Patent Application Publication
(10) Pub. No.: US 2026/0303646 A1
(43) Pub. Date: Oct. 1, 2026

(54) VULNERABILITY PROCESSING SYSTEM AND VULNERABILITY PROCESSING METHOD

(71) Applicant: Panasonic Automotive Systems Co., Ltd., Kanagawa (JP)

(72) Inventors: Toru IWANO, Osaka (JP); Tomoyuki HAGA, Nara (JP); Yuishi TORISAKI, Osaka (JP); Shoichiro SEKIYA, Osaka (JP); Ryo WATANABE, Osaka (JP)

(73) Assignee: Panasonic Automotive Systems Co., Ltd., Kanagawa (JP)

(21) Appl. No.: 19/452,708

(22) Filed: Jan. 19, 2026

(30) Foreign Application Priority Data
Mar. 28, 2025 (JP) 2025-055463

(51) Int. Cl. H04L 9/40

(52) U.S. Cl. CPC H04L 63/1433

(57) ABSTRACT

A vulnerability processing system includes a scenario evaluator. The scenario evaluator includes: a mitigation selector that selects a plurality of mitigations against a vulnerability; a lead time identifier that identifies a lead time of each of the plurality of mitigations; an impact level identifier that identifies, for each of the plurality of mitigations, a degree of impact as an impact level, the impact being to be exerted by the mitigation on a system having the vulnerability; a narrower that extracts one or more mitigations from the plurality of mitigations by narrowing down the plurality of mitigations; and a generator that generates a mitigation report indicating the one or more mitigations extracted.

### CROSS REFERENCE TO RELATED APPLICATION

The present application is based on and claims priority of Japanese Patent Application No. 2025-055463 filed on Mar. 28, 2025.

### FIELD

The present disclosure relates to a vulnerability processing system and the like for performing vulnerability-related processing.

### BACKGROUND

In recent years, rapid advances have been made in automotive functions, for example, external connectivity, autonomous driving, automated control, and in-vehicle infotainment (IVI). Such functional advances, as well as the integration of electronic control units (ECUs) and the development of software-defined vehicles (SDVs), have been increasing the importance of addressing security risks to automobiles, including addressing vulnerabilities in systems such as ECUs. While the number of vulnerability reports may average, for example, 108 reports per day, responding to all the reported vulnerabilities equally and immediately is difficult. As such, a vulnerability triage system has been proposed that derives the response priority of each vulnerability, i.e., the priority of responding to the vulnerability. Based on the response priority, the system allows readily finding a vulnerability requiring immediate response from among a large number of vulnerabilities discovered.

Patent Literature (PTL) 1 proposes a security risk management system that selects multiple mitigation options for reducing a security risk exceeding the acceptable level of a system. The security risk is evaluated based on factors such as the presence of a vulnerability. If a vulnerability requiring immediate response is found, at least one of mitigation options selected by the security risk management system against the vulnerability can be performed to reduce a security risk.

### CITATION LIST

### Patent Literature

PTL 1: Japanese Patent Publication No. 5304243

### SUMMARY

Unfortunately, the security risk management system in PTL 1 can be improved upon.

In view of the above, the present disclosure provides a vulnerability processing system and the like that are capable of improving upon the above related art.

A vulnerability processing system according to one aspect of the present disclosure includes: a mitigation selector that selects a plurality of mitigations against a vulnerability; a lead time identifier that identifies a lead time of each of the plurality of mitigations; an impact level identifier that identifies, for each of the plurality of mitigations, a degree of impact as an impact level, the impact being to be exerted by the mitigation on a system having the vulnerability; a narrower that extracts one or more mitigations from the plurality of mitigations by narrowing down the plurality of mitigations, based on the lead time and the impact level that are identified; and a generator that generates a mitigation report indicating the one or more mitigations extracted.

It should be noted that such general or specific aspect may be implemented using a device, a method, an integrated circuit, a computer program, or a computer-readable recording medium such as a CD-ROM, or any combination of devices, methods, integrated circuits, computer programs, or computer-readable recording media. The recording media may be non-transitory recording media.

The vulnerability processing system according to the present disclosure is capable of improving upon the above related art.

It should be noted that further merits and advantageous effects in one aspect of the present disclosure will become apparent from the following description and drawings. These merits and/or advantageous effects are provided by the elements described in the following embodiment, description, and drawings. However, not all of such elements are necessarily required.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating an example of the functional configuration of a vulnerability processing system in this embodiment.

FIG. 2 is a diagram illustrating an example of information stored in each database in this embodiment.

FIG. 3 is a diagram illustrating an example of the functional configuration of a scenario evaluator in this embodiment.

FIG. 4 is a diagram illustrating an example of a mitigation report that is output by the vulnerability processing system in this embodiment.

FIG. 5 is a diagram for describing the content of the mitigation report in this embodiment.

FIG. 6 is a flowchart illustrating an example of a process performed by an investigator in this embodiment.

FIG. 7 is a flowchart illustrating an example of a process performed by the scenario evaluator in this embodiment.

### DESCRIPTION OF EMBODIMENT

A vulnerability processing system according to a first aspect of the present disclosure includes: a mitigation selector that selects a plurality of mitigations against a vulnerability; a lead time identifier that identifies a lead time of each of the plurality of mitigations; an impact level identifier that identifies, for each of the plurality of mitigations, a degree of impact as an impact level, the impact being to be exerted by the mitigation on a system having the vulnerability; a narrower that extracts one or more mitigations from the plurality of mitigations by narrowing down the plurality of mitigations, based on the lead time and the impact level that are identified; and a generator that generates a mitigation report indicating the one or more mitigations extracted. The impact level may be considered an indication of, for example, the degree to which the functionality and operation of the system are disrupted.

Thus, the mitigations are narrowed down quantitatively based on the lead time and the impact level. This enables appropriate mitigations against the vulnerability to be derived and presented to a user. In other words, the security risk management system in PTL 1 has difficulty deriving appropraite mitigations against a vulnerability. In contrast, the vulnerability processing system and the like provided by the present disclosure makes it possible to derive appropraite mitigations against a vulnerability.

In a vulnerability processing system according to a second aspect, the narrower may extract a temporary mitigation and a drastic mitigation as the one or more mitigations from the plurality of mitigations, the temporary mitigation being a mitigation temporarily taken against the vulnerability, the drastic mitigation being a mitigation drastically taken against the vulnerability. It should be noted that the second aspect may depend from the first aspect. In an example, the lead time of the temporary mitigation is shorter than the lead time of the drastic mitigation, while the impact level of the temporary mitigation is higher than the impact level of the drastic mitigation. In a specific example, the temporary mitigation involves disabling a function of software residing in the system, and the drastic mitigation involves updating software having the vulnerability. It is to be noted that the temporary mitigation may involve disabling a function of software different from the software having the vulnerability.

Thus, the temporary mitigation can immediately address the vulnerability, and thereafter, the drastic mitigation can fundamentally address the vulnerability. This enables immediate and effective reduction of the risk of cyberattacks that exploit the vulnerability. For example, while the drastic mitigation may involve software update and require time for testing software and releasing an updated version of the software, the temporary mitigation can immediately address the vulnerability. That is, in the second aspect, the mitigation report indicating a temporary mitigation and a drastic mitigation can be generated to appropriately present mitigations that should be performed for earlier reduction of the risk posed by the vulnerability.

In a vulnerability processing system according to a third aspect, the narrower may extract a mitigation having the impact level that is less than a threshold value from the plurality of mitigations. It should be noted that the third aspect may depend from the first aspect or the second aspect. As the impact level of a mitigation is higher, the mitigation has greater impact on the system having the vulnerability, for example, the driving or functionality of a vehicle equipped with the system having the vulnerability is more disrupted.

Thus, mitigations having impact levels below the threshold value are extracted. This can minimize disruption in the driving and functionality of the vehicle.

In a vulnerability processing system according to a fourth aspect, the narrower may: identify a response priority of the vulnerability; determine a period based on the response priority as a base period; and extract a mitigation having the lead time that falls within the base period from the plurality of mitigations. It should be noted that the fourth aspect may depend from any one of the first aspect to the third aspect.

Thus, the mitigation report indicates mitigations that can be performed within the base period corresponding to the response priority. This can prevent, for example, the mitigation report from indicating a mitigation having a high response priority for the vulnerability but having a long lead time. An example of such a mitigation having a long lead time is a mitigation requiring considerable time to update software and further to release the updated software.

In a vulnerability processing system according to a fifth aspect, the narrower may determine the base period that becomes longer as the response priority becomes lower. It should be noted that the fifth aspect may depend from the fourth aspect.

Thus, an appropriate base period can be set based on the response priority.

In a vulnerability processing system according to a sixth aspect, the narrower may: determine whether the one or more mitigations extracted include the drastic mitigation; and when the one or more mitigations extracted do not include the drastic mitigation, extend the base period by decreasing the response priority identified, and perform the narrowing down again using the base period extended. It should be noted that the sixth aspect may depend from the fifth aspect.

This can ensure that the mitigation report includes a drastic mitigation, enabling effectively addressing the vulnerability.

A vulnerability processing system according to a seventh aspect further includes an investigator that obtains information about software as software information by investigating at least one of the vulnerability or a mitigation, the software being to be addressed by a mitigation against the vulnerability. The generator may include the software information in the mitigation report. It should be noted that the seventh aspect may depend from any one of the first aspect to the sixth aspect.

Thus, the mitigation report includes the software information, enabling the user to readily recognize the software to be addressed by each mitigation.

A vulnerability processing system according to an eighth aspect further includes an investigator that obtains information for identifying a performer as performer information by investigating at least one of the vulnerability or a mitigation, the performer taking a mitigation against the vulnerability. The generator may include the performer information in the mitigation report. It should be noted that the eighth aspect may depend from any one of the first aspect to the seventh aspect.

Thus, the mitigation report includes the performer information, enabling the user to readily recognize the performer that is to perform each mitigation.

In a vulnerability processing system according to a ninth aspect, the lead time identifier may identify the lead time by referring to dynamic information about the vulnerability updated sequentially. It should be noted that the ninth aspect may depend from any one of the first aspect to the eighth aspect. Examples of the dynamic information include SW homepage information, SIRT-related information, SOC-related information, and test tool information, which will be described below.

Thus, for example, after the vehicle equipped with the above system of interest is shipped, appropriate mitigations against the vulnerability can still be derived with reference to the latest dynamic information and presented to the user.

A vulnerability processing method according to a tenth aspect of the present disclosure is a vulnerability processing method executed by a computer, and includes: selecting a plurality of mitigations against a vulnerability; identifying a lead time of each of the plurality of mitigations; identifying, for each of the plurality of mitigations, a degree of impact as an impact level, the impact being to be exerted by the mitigation on a system having the vulnerability; extracting one or more mitigations from the plurality of mitigations by narrowing down the plurality of mitigations, based on the lead time and the impact level that are identified; and generating a mitigation report indicating the one or more mitigations extracted.

The method can provide advantageous effects similar to those of the vulnerability processing system according to the first aspect.

Hereinafter, an embodiment is described in details with reference to the Drawings.

It should be noted that the embodiment described below shows a general or specific example. The numerical values, shapes, materials, constituent elements, the arrangement and connection of the constituent elements, steps, the order of the steps, etc. shown in the following embodiment are mere examples, and thus are not intended to limit the scope of the present disclosure. In addition, among the constituent elements in the following embodiment, those not recited in any one of the independent claims are described as optional constituent elements.

Moreover, each of figures is a schematic diagram and is not necessarily an exact illustration. Additionally, in each figure, the same constituent elements are assigned the same reference signs.

### Embodiment

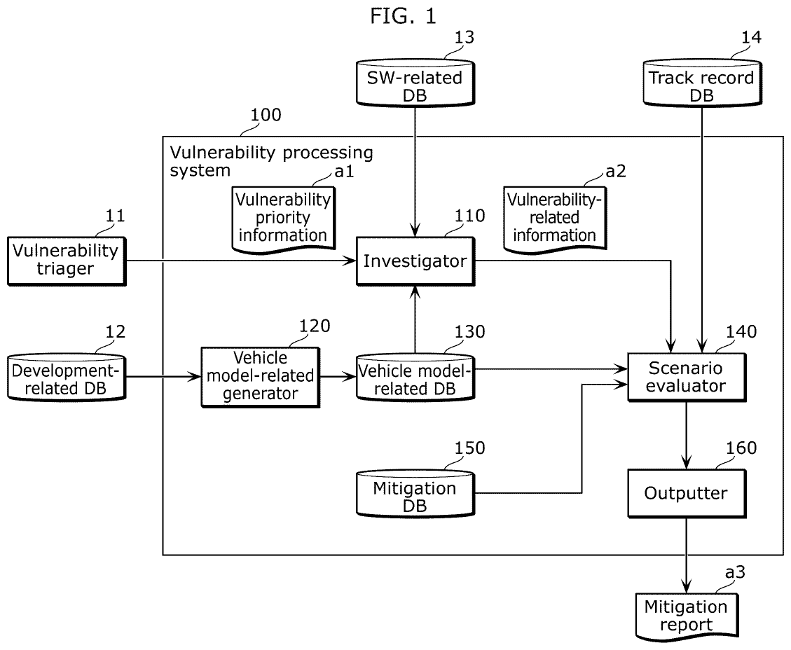

FIG. 1 is a diagram illustrating an example of the functional configuration of a vulnerability processing system in this embodiment.

Vulnerability processing system 100 in this embodiment obtains vulnerability priority information a1 output from vulnerability triager 11, and outputs mitigation report a3 indicating mitigations against a vulnerability indicated in vulnerability priority information a1. As such, vulnerability processing system 100 may be called a vulnerability mitigation evaluation system or a vulnerability response policy automatic determination system. It is to be noted that vulnerability triager 11 is the aforementioned vulnerability triage system.

To generate mitigation report a3, vulnerability processing system 100 refers to development-related database 12, software (SW)-related database 13, and track record database 14. Database is also denoted as DB. Development-related database 12 is a recording medium that stores information about the development, analysis, safety, and other aspects of information processing systems provided in vehicles (hereinafter referred to as in-vehicle systems), for example on a vehicle model basis. This information may be considered static information, because the information is not updated once the vehicles or the in-vehicle systems are shipped. SW-related database 13 is a recording medium that stores software information. Track record database 14 is a recording medium that stores information about vulnerabilities discovered and addressed in the past. The information stored in SW-related database 13 or track record database 14 may be considered dynamic information, because the information is updated sequentially still after the shipment of the vehicles or the in-vehicle systems.

Vulnerability processing system 100 includes investigator 110, vehicle model-related generator 120, vehicle model-related database 130, scenario evaluator 140, mitigation database 150, and outputter 160.

Vehicle model-related generator 120 obtains information about the development and other aspects of an in-vehicle system for a vehicle model under evaluation from development-related database 12, and evaluates the obtained information to generate vehicle model-specific evaluation information. The vehicle model-specific evaluation information may be considered information specific to the vehicle model under evaluation. Vehicle model-related generator 120 stores the vehicle model-specific evaluation information in vehicle model-related database 130. The above in-vehicle system for the vehicle model under evaluation will hereinafter also be referred to as a system under evaluation.

Vehicle model-related database 130 is a recording medium for storing the above vehicle model-specific evaluation information.

Investigator 110 obtains aforementioned vulnerability priority information a1 from vulnerability triager 11. Investigator 110 then obtains, from SW-related database 13, information about software having the vulnerability indicated in vulnerability priority information a1. For example, the information about the software indicates the name and the update status (e.g., the version) of each software item. Investigator 110 further refers to the vehicle model-specific evaluation information in vehicle model-related database 130 to identify the use, function, and other aspects, in the system under evaluation, of each software item having the vulnerability. Investigator 110 generates vulnerability-related information a2 indicating the name, update status, use, function, and other aspects of each software item, which is then output to scenario evaluator 140.

Scenario evaluator 140 receives vulnerability-related information a2 from investigator 110 and selects, based on vulnerability-related information a2, mitigations corresponding to vulnerability-related information a2 from mitigation database 150. Mitigation database 150 is a recording medium that stores information indicating mitigations. Scenario evaluator 140 narrows down the selected mitigations by referring to information in track record database 14 and information in vehicle model-related database 130. That is, scenario evaluator 140 extracts one or more mitigations from the selected mitigations. Scenario evaluator 140 generates mitigation report a3, which is information indicating the one or more extracted mitigations.

Outputter 160 outputs mitigation report a3 generated by scenario evaluator 140 to the outside of vulnerability processing system 100.

The above-described recording media in this embodiment, such as development-related database 12, may each be a hard disk drive, a random access memory (RAM), a read only memory (ROM), or a semiconductor memory. The recording media may be volatile or nonvolatile.

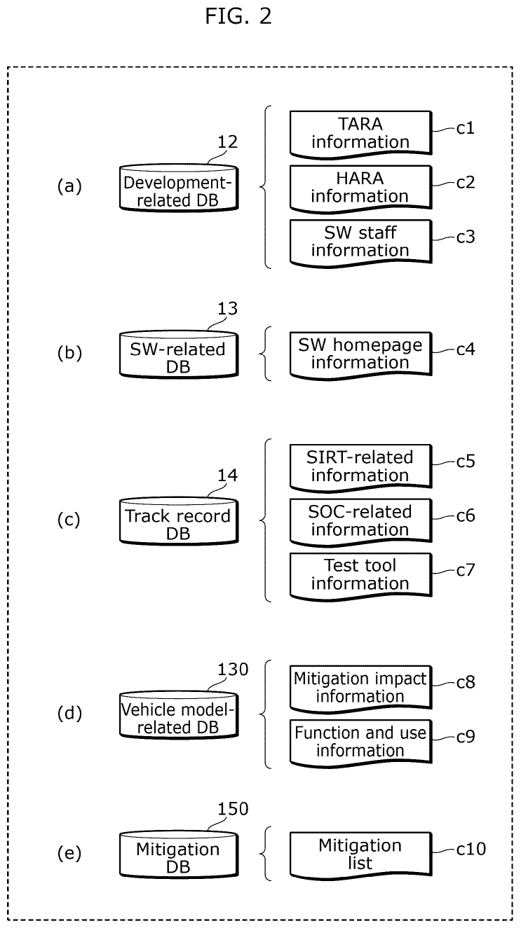

FIG. 2 is a diagram illustrating an example of information stored in each database in this embodiment.

As shown at (a) in FIG. 2, development-related database 12 stores TARA information c1, HARA information c2, and SW staff information c3 as information about the development, analysis, safety, and other aspects of each in-vehicle system. TARA information c1 is information about threat analysis and risk assessment, indicating, for example, the vehicle configuration, the in-vehicle system configuration, data flows, and the asset value of each function. HARA information c2 is information about hazard analysis and risk assessment, including, for example, information on the automotive safety integrity level (ASIL). SW staff information c3 indicates the person in charge of the development of each software item residing in the in-vehicle system. It is to be noted that SW staff information c3 may be included in management software for the development project of the in-vehicle system. TARA information c1, HARA information c2, and SW staff information c3 may be considered static information, because these information items are updated at a relatively low frequency once the vehicles or the in-vehicle systems are developed.

As shown at (b) in FIG. 2, SW-related database 13 stores SW homepage information c4 as software information. For each software item, SW homepage information c4 indicates which version of the software item has what vulnerability. SW homepage information c4 may also indicate mitigations previously performed against the vulnerability. That is, SW homepage information c4 may be considered to include release notes and security information.

As shown at (c) in FIG. 2, track record database 14 stores SIRT-related information c5, SOC-related information c6, and test tool information c7 as information about vulnerabilities discovered and mitigated in the past. SIRT-related information c5 is information about mitigations performed by a security incident response team (SIRT) against vulnerabilities in the past. SOC-related information c6 is information about mitigations performed by a security operation center (SOC) against vulnerabilities in the past. Information about a mitigation against a vulnerability includes the time required to respond to the vulnerability log, the time required to prepare the mitigation, and the time required to update software by applying the mitigation to the software. Test tool information c7 indicates information such as the time required to test each mitigation against vulnerabilities discovered in the past, the time required to test software addressed by the mitigation, and test coverage. SW homepage information c4, SIRT-related information c5, SOC-related information c6, and test tool information c7 above may be considered dynamic information, because these information items are modified even after the shipment of the vehicles or the in-vehicle systems, for example whenever vulnerabilities are discovered.

As shown at (d) in FIG. 2, vehicle model-related database 130 stores mitigation impact information c8 and function and use information c9 as the above-described vehicle model-specific evaluation information. Mitigation impact information c8 indicates the impact level of each mitigation, which is the degree of impact of the mitigation on the system under evaluation. The impact level, indicating the degree to which the functionality and operation of the system under evaluation are disrupted, may be considered the level of adverse effects on the system under evaluation. Function and use information c9 indicates the function and use of each software item residing in the system under evaluation. Investigator 110 refers to function and use information c9 to identify the function and use of each software item having the vulnerability indicated in vulnerability priority information a1.

As shown at (e) in FIG. 2, mitigation database 150 stores mitigation list c10. Mitigation list c10 is information indicating mitigations against each of vulnerabilities. In mitigation list c10, each mitigation is predefined as either a temporary mitigation or a drastic mitigation, which will be described below.

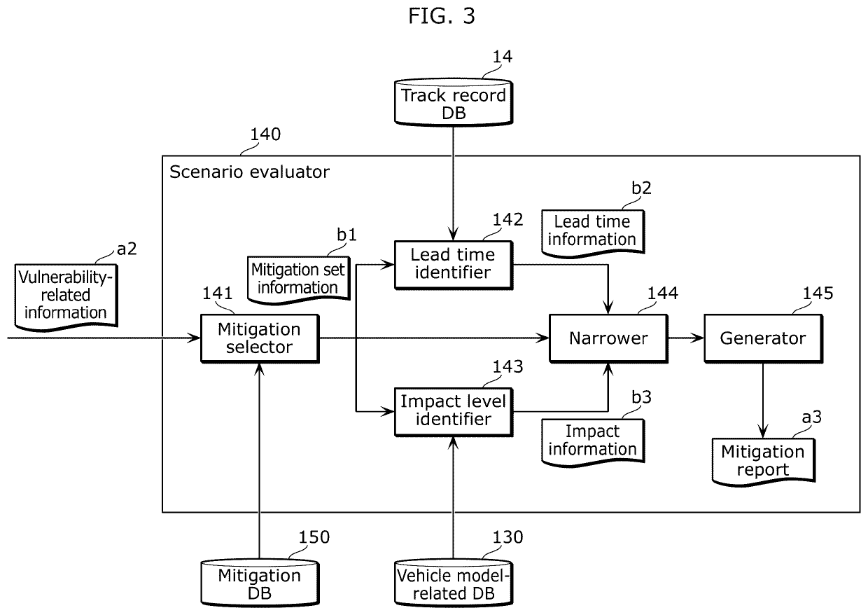

FIG. 3 is a diagram illustrating an example of the functional configuration of scenario evaluator 140 in this embodiment.

Scenario evaluator 140 includes mitigation selector 141, lead time identifier 142, impact level identifier 143, narrower 144, and generator 145.

Mitigation selector 141 receives vulnerability-related information a2 and selects, from mitigation list c10 in mitigation database 150, mitigations against the vulnerability indicated in vulnerability-related information a2. Mitigation selector 141 outputs mitigation set information b1 including the selected mitigations to lead time identifier 142, impact level identifier 143, and narrower 144.

Lead time identifier 142 receives mitigation set information b1 from mitigation selector 141 and identifies the lead time of each mitigation in mitigation set information b1. For this purpose, lead time identifier 142 refers to SIRT-related information c5, SOC-related information c6, and test tool information c7 in track record database 14. Lead time identifier 142 thus identifies, as the lead time of each mitigation in mitigation set information b1, the time required to perform a mitigation identical or similar to that mitigation. Lead time identifier 142 generates lead time information b2 indicating the lead time of each mitigation, and outputs lead time information b2 to narrower 144.

Impact level identifier 143 receives mitigation set information b1 from mitigation selector 141 and identifies the impact level of each mitigation in mitigation set information b1, which is the degree of impact of the mitigation on the vulnerable system under evaluation. Specifically, impact level identifier 143 identifies the impact level of each mitigation by referring to mitigation impact information c8 in vehicle model-related database 130. Impact level identifier 143 generates impact information b3 indicating the impact level of each mitigation, and outputs impact information b3 to narrower 144.

Narrower 144 receives mitigation set information b1 from mitigation selector 141, lead time information b2 from lead time identifier 142, and impact information b3 from impact level identifier 143. Based on lead time information b2 and impact information b3, narrower 144 narrows down the mitigations in mitigation set information b1. This narrowing down allows narrower 144 to extract one or more of the mitigations. That is, narrower 144 narrows down the mitigations based on the identified lead times and impact levels to extract one or more of the mitigations.

Generator 145 generates and outputs mitigation report a3 indicating the one or more mitigations extracted by narrower 144.

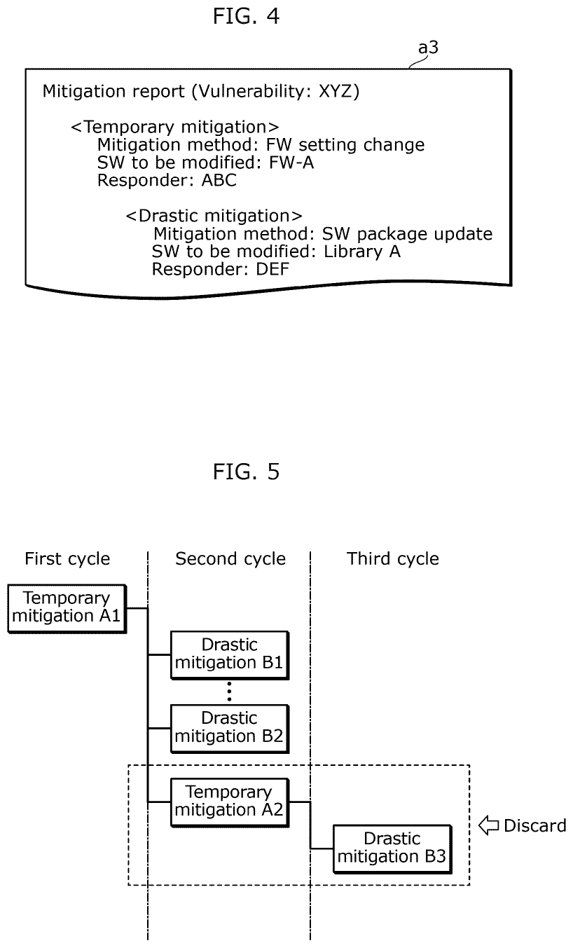

FIG. 4 is a diagram illustrating an example of mitigation report a3 output by vulnerability processing system 100 in this embodiment.

As shown in FIG. 4 as an example, mitigation report a3 indicates a temporary mitigation and a drastic mitigation as the one or more mitigations extracted by narrowing down. A temporary mitigation is to be performed temporarily against the vulnerability, whereas a drastic mitigation is to be performed drastically against the vulnerability. That is, narrower 144 in this embodiment extracts, as the one or more mitigations from mitigation set information b1, a temporary mitigation to be performed temporarily against the vulnerability and a drastic mitigation to be performed drastically against the vulnerability.

The temporary mitigation is, for example, the mitigation method “FW (firmware) setting change” against the vulnerability “XYZ.” Associated with this temporary mitigation are the software to be modified “FW-A” and the responder “ABC.” This temporary mitigation is performed by the responder “ABC” on the software to be modified “FW-A.”

The vulnerability “XYZ” is the identification information of the vulnerability, which may be, for example, a CVE (common vulnerabilities and exposures)-ID. The software to be modified “FW-A” is the name of the software. The responder “ABC” is the name or department name of the person in charge of the development of the software. That is, when selecting a temporary mitigation, mitigation selector 141 associates software to be modified, i.e., the name of the software indicated in vulnerability-related information a2, with the selected temporary mitigation. Mitigation selector 141 further associates a responder, i.e., the name or department name of the person in charge of the development of the software, indicated in SW staff information c3, with the selected temporary mitigation. Thus, the software to be modified and the responder are associated with the temporary mitigation and indicated in mitigation report a3.

The drastic mitigation is, for example, the mitigation method “SW package update” against the vulnerability “XYZ.” Associated with this drastic mitigation are the software to be modified “Library A” and the responder “DEF.” This drastic mitigation is performed by the responder “DEF” on the software to be modified “Library A” after the above temporary mitigation.

The software to be modified “Library A” is the name of the software. The responder “DEF” is the name or department name of the person in charge of the development of the software. That is, as in the above, when selecting a drastic mitigation, mitigation selector 141 associates software to be modified, i.e., the name of the software indicated in vulnerability-related information a2, with the selected drastic mitigation. Mitigation selector 141 further associates a responder, i.e., the name or department name of the person in charge of the development of the software, indicated in SW staff information c3, with the selected drastic mitigation. Thus, the software to be modified and the responder are associated with the drastic mitigation and indicated in mitigation report a3.

In the above example, the software to be modified is software indicated in vulnerability-related information a2 and having the vulnerability indicated in vulnerability priority information a1. The software having the vulnerability will hereinafter also be referred to as vulnerable software. However, the software to be modified may be different from the vulnerable software. Software different from the vulnerable software will hereinafter also be referred to as non-vulnerable software. For example, to address the vulnerable software, scenario evaluator 140 identifies non-vulnerable software to be modified in place of the vulnerable software based on information such as a software back trace or TARA information c1. The software backtrace is, for example, the backtrace of multiple software items residing in the system under evaluation, and specifically, the backtrace of a software group that includes the vulnerable software. Scenario evaluator 140 associates the name of the non-vulnerable software with the selected temporary or drastic mitigation. Thus, the non-vulnerable software, i.e., the software to be modified, and the responder are associated with the temporary or drastic mitigation and indicated in mitigation report a3. If the selected temporary or drastic mitigation specifies the name of the software to be modified, which may be the vulnerable software or non-vulnerable software, scenario evaluator 140 may associate the specified name of the software to be modified with the selected temporary or drastic mitigation.

Thus, in this embodiment, a temporary mitigation and a drastic mitigation are extracted and included in mitigation report a3. The temporary mitigation can immediately address the vulnerability, and thereafter, the drastic mitigation can fundamentally address the vulnerability. This enables immediate and effective reduction of the risk of cyberattacks that exploit the vulnerability. For example, while the drastic mitigation may involve software update and require time for testing software and releasing an updated version of the software, the temporary mitigation can immediately address the vulnerability. That is, in this embodiment, mitigation report a3 indicating a temporary mitigation and a drastic mitigation can be generated to appropriately present mitigations that should be performed for earlier reduction of the risk posed by the vulnerability.

The lead time of the temporary mitigation may be shorter than the lead time of the drastic mitigation, while the impact level of the temporary mitigation may be higher than the impact level of the drastic mitigation. In a specific example, the temporary mitigation involves changing a setting of or disabling a function of software residing in the in-vehicle system, and the drastic mitigation involves updating software having the vulnerability. It is to be noted that the temporary mitigation may involve changing a setting of or disabling a function of software different from the software having the vulnerability.

FIG. 5 is a diagram for describing the content of mitigation report a3 in this embodiment.

If the mitigations extracted by narrower 144 include mitigations to be performed in the third or subsequent cycle, generator 145 excludes these mitigations to generate mitigation report a3.

For example, generator 145 determines that the mitigations extracted by narrower 144 are temporary mitigation A1, drastic mitigation B1, drastic mitigation B2, temporary mitigation A2, and drastic mitigation B3. Temporary mitigation A1 is the first mitigation to be performed against the vulnerability. Drastic mitigation B1, drastic mitigation B2, and temporary mitigation A2 are each the second mitigation to be performed after the first mitigation. Drastic mitigation B3 is the third mitigation to be performed after temporary mitigation A2. In this case, generator 145 excludes the third mitigation, i.e., drastic mitigation B3, from mitigation report a3 being generated. Now that drastic mitigation B3 is not performed as the third mitigation, temporary mitigation A2 to be performed as the second mitigation would be incomplete as a mitigation against the vulnerability. Therefore, generator 145 also excludes temporary mitigation A2 from mitigation report a3 being generated. That is, generator 145 discards temporary mitigation A2 and drastic mitigation B3 and generates mitigation report a3 containing temporary mitigation A1, drastic mitigation B1, and drastic mitigation B2.

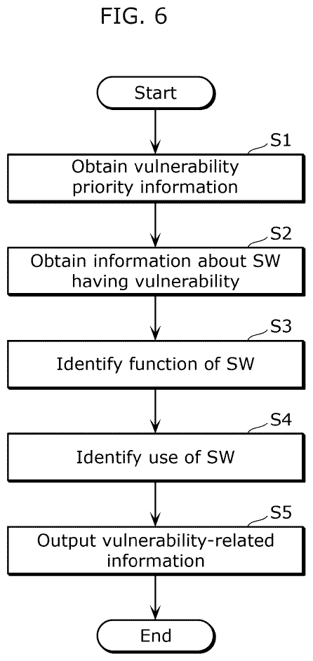

FIG. 6 is a flowchart illustrating an example of a process performed by investigator 110 in this embodiment.

Investigator 110 obtains vulnerability priority information a1 from vulnerability triager 11 (step S1). Investigator 110 then obtains, from SW-related database 13, information about software having a vulnerability indicated in vulnerability priority information a1 (step S2). The information about the software indicates, for example, the name and the update status of each software item.

Investigator 110 refers to vehicle model-related database 130 (specifically, function and use information c9) to identify the function that each software item has in the system under evaluation (step S3). The function is, for example, the over-the-air (OTA) function of the vehicle. The OTA function enables remotely managing and updating software or firmware of the vehicle through wireless communication. The identified function may indicate additional information, such as the importance or risks that the function has in the vehicle.

Investigator 110 further refers to vehicle model-related database 130 (specifically, function and use information c9) to identify the use that each software item has in the system under evaluation (step S4). The use is, for example, the brakeage of the vehicle.

Investigator 110 generates and outputs vulnerability-related information a2 indicating the name, update status, function, use, and other aspects of each software item (step S5).

Thus, in this embodiment, at step S2, investigator 110 investigates the vulnerability and/or mitigations to obtain software information, which is information about software to be addressed by the mitigations against the vulnerability. The software information indicates the name and other aspects of each software item. Generator 145 then includes the software information in mitigation report a3. For example, mitigation report a3 indicates the software information as software to be modified. Because mitigation report a3 includes the software information, the user can readily recognize the software to be addressed by each mitigation.

At step S2, investigator 110 may also obtain information, such as the above-described name of the person in charge, from SW staff information c3 in development-related database 12, and include the information in vulnerability-related information a2. The person in charge is the performer that is to perform each mitigation against the vulnerability, and is the above-described responder. That is, investigator 110 investigates the vulnerability and/or mitigations to obtain performer information, which is information (e.g., the name of the person in charge) for identifying the performer that is to perform each mitigation against the vulnerability. Generator 145 then includes the performer information in mitigation report a3. For example, mitigation report a3 indicates the performer information as responders. Because mitigation report a3 includes the performer information, the user can readily recognize the performer that is to perform each mitigation.

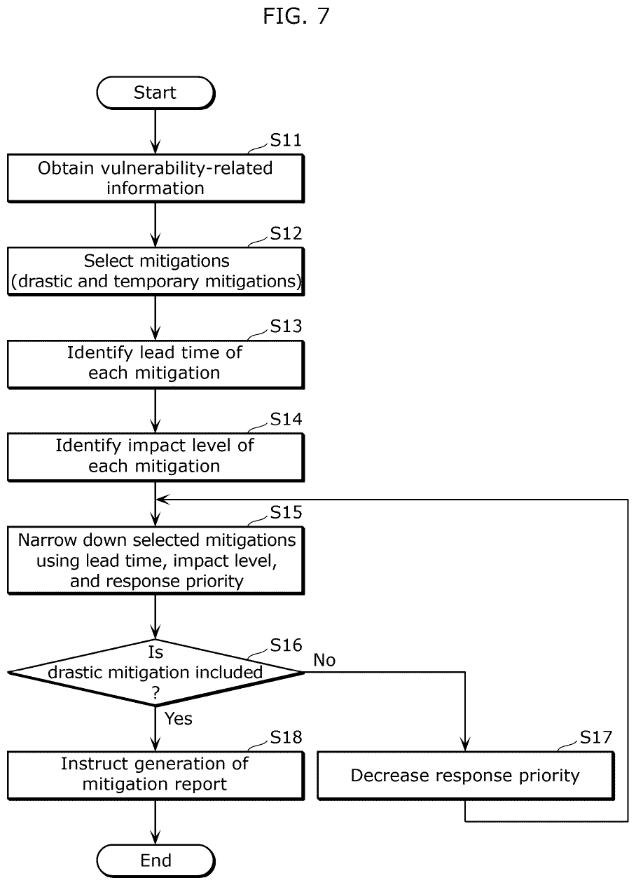

FIG. 7 is a flowchart illustrating an example of a process performed by scenario evaluator 140 in this embodiment.

Mitigation selector 141 of scenario evaluator 140 obtains vulnerability-related information a2 from investigator 110 (step S11). Mitigation selector 141 then selects, from mitigation list c10 in mitigation database 150, mitigations associated with the names, update statuses, functions, uses, and other aspects of the software indicated in vulnerability-related information a2 (step S12). At this point, multiple mitigations are selected. Each mitigation is either a temporary mitigation or a drastic mitigation. Mitigation selector 141 generates and outputs mitigation set information b1 indicating the selected mitigations.

In a specific example, mitigation set information b1 indicates a first mitigation, which is a drastic mitigation; a second mitigation, which is a temporary mitigation; and a third mitigation, which is also a temporary mitigation. The first mitigation involves software update. The second mitigation involves disabling the OTA function. The third mitigation involves enhancing a firmware function and adding rules regarding senders of data directed to the vehicle.

Lead time identifier 142 identifies the lead time of each mitigation indicated in mitigation set information b1 (step S13). Lead time identifier 142 generates lead time information b2 indicating the lead time of each mitigation. For example, lead time identifier 142 refers to SIRT-related information c5 and SOC-related information c6 in track record database 14 to identify the time (hereinafter referred to as a first time) required to perform a mitigation against a vulnerability discovered in the past. The vulnerability discovered in the past is identical or similar to the vulnerability indicated in vulnerability priority information a1, and will be referred to as a past similar vulnerability. The mitigation performed against the past similar vulnerability is identical or similar to each mitigation indicated in mitigation set information b1, and will be referred to as a past similar mitigation. Lead time identifier 142 also refers to test tool information c7 in track record database 14 to identify the time (hereinafter referred to as a second time) required to test the above past similar mitigation. Lead time identifier 142 adds up the first time and the second time to determine the above lead time. The lead time may be expressed in days.

In a specific example, lead time identifier 142 identifies the lead times of the first, second, and third mitigations as 60 days, 1 day, and 2 days, respectively.

Impact level identifier 143 identifies the impact level of each mitigation indicated in mitigation set information b1 (step S14). Impact level identifier 143 generates impact information b3 indicating the impact level of each mitigation. For example, impact level identifier 143 refers to mitigation impact information c8 in vehicle model-related database 130 to identify the impact level associated with each mitigation indicated in mitigation set information b1. The impact level may be expressed as, for example, high, medium, or low, or a numerical value within the range of 0 to 10.

In a specific example, impact level identifier 143 identifies the impact levels of the first, second, and third mitigations as 0, 10, and 5, respectively. That is, the impact level of the first mitigation, involving software update, is identified as 0 (i.e., “low”). The impact level of the second mitigation, involving disabling the OTA function, is identified as 10 (i.e., “high”). This is because disabling the OTA function significantly restricts the functionality of the system under evaluation. The impact level of the third mitigation, involving enhancing a firmware function and adding rules, is identified as 5 (i.e., “medium”). This is because the third mitigation restricts some of the functionality of the system under evaluation.

Narrower 144 narrows down the mitigations indicated in mitigation set information b1 to extract one or more of the mitigations (step S15). For narrowing down, narrower 144 uses the lead time of each mitigation indicated in lead time information b2, the impact level of each mitigation indicated in impact information b3, and the response priority of the vulnerability indicated in vulnerability priority information a1.

That is, narrower 144 identifies the response priority indicated in vulnerability priority information a1 and determines a base period based on the response priority. Narrower 144 compares the lead time of each mitigation with the base period. For example, narrower 144 determines a longer base period for a lower response priority. Narrower 144 further compares the impact level of each mitigation with a predetermined threshold. Narrower 144 extracts, from the mitigations, one or more mitigations that each have a lead time within the base period and an impact level below the threshold. It is to be noted that, as with the base period, the threshold may be determined by narrower 144 based on the response priority. In that case, narrower 144 may determine a smaller threshold for a higher response priority.

In a specific example, the base period is “10 days” and the threshold is “7.” The first mitigation has the lead time “60 days,” which is longer than the base period “10 days,” i.e., not within the base period. The first mitigation is therefore not extracted by the above-described narrowing down. The second mitigation has the impact level “10,” which is greater than the threshold “7,” i.e., not below the threshold. The second mitigation is therefore not extracted by the above-described narrowing down. Consequently, narrower 144 extracts only the third mitigation from the first, second, and third mitigations.

Narrower 144 determines whether the one or more mitigations extracted by the narrowing down include a drastic mitigation (step S16). If narrower 144 determines that the one or more mitigations include a drastic mitigation (step S16: Yes), narrower 144 instructs generator 145 to generate mitigation report a3 indicating the one or more mitigations (step S18). In contrast, if narrower 144 determines that the one or more mitigations include no drastic mitigations (step S16: No), narrower 144 decreases the response priority used at step S15 (step S17). Narrower 144 then repeats the process from step S15.

In a specific example, the one or more mitigations extracted by the narrowing down include only the third mitigation, which is a temporary mitigation. In this case, narrower 144 determines that the one or more mitigations extracted by the narrowing down include no drastic mitigations. Narrower 144 then decreases the response priority used at step S15 and determines a base period based on the decreased response priority, for example the base period “60 days.” Narrower 144 uses the base period “60 days” to perform the processing of narrowing down at step S15. This time, at step S15, narrower 144 also extracts the first mitigation from the first, second, and third mitigations indicated in mitigation set information b1. The first mitigation is a drastic mitigation. Therefore, at step S16, narrower 144 determines that the extracted first and third mitigations include a drastic mitigation (step S16: Yes), and instructs generator 145 to generate mitigation report a3 indicating the first and third mitigations (step S18).

Thus, in this embodiment, the mitigations are narrowed down quantitatively based on the lead time and the impact level. This enables appropriate mitigations against the vulnerability to be derived and presented to the user.

Furthermore, in this embodiment, narrower 144 extracts mitigations having impact levels below the threshold from the mitigations in mitigation set information b1. Because mitigations having impact levels below the threshold are extracted, disruption in the driving and functionality of the vehicle can be minimized. It is to be noted that, as the impact level of a mitigation is higher, the mitigation has greater impact on the vulnerable system under evaluation, for example, the driving or functionality of the vehicle equipped with the system under evaluation is more disrupted.

Furthermore, in this embodiment, narrower 144 identifies the response priority of the vulnerability and determines, as a base period, a period based on the response priority. Narrower 144 extracts, from the mitigations, those having lead times within the base period. Thus, mitigation report a3 indicates mitigations that can be performed within the base period corresponding to the response priority. This can prevent, for example, mitigation report a3 from indicating a mitigation having a high response priority for the vulnerability but having a long lead time. An example of such a mitigation having a long lead time is a mitigation requiring considerable time to update software and further to release the updated software.

Furthermore, in this embodiment, a base period that becomes longer as a response priority becomes lower is determined. Thus, an appropriate base period can be set based on the response priority.

Furthermore, in this embodiment, narrower 144 determines whether the extracted one or more mitigations include a drastic mitigation. If no drastic mitigations are included, narrower 144 extends the base period by decreasing the identified response priority and performs the narrowing down again using the extended base period. This can ensure that mitigation report a3 includes a drastic mitigation, enabling effectively addressing the vulnerability.

Furthermore, in this embodiment, lead time identifier 142 identifies the lead time by referring to dynamic vulnerability information that is updated sequentially. Examples of the dynamic information include SW homepage information c4, SIRT-related information c5, SOC-related information c6, and test tool information c7. Thus, for example, after the vehicle equipped with the system under evaluation is shipped, appropriate mitigations against the vulnerability can still be derived with reference to the latest dynamic information and presented to the user.

Now, vulnerability processing system 100 in this embodiment may also perform the following processing.

For example, scenario evaluator 140 may determine the details of each of the one or more mitigations extracted from mitigation set information b1. That is, scenario evaluator 140 may determine the details of each of the one or more mitigations based on information such as release information in SW homepage information c4, a software backtrace, and TARA information c1. The release information indicates information such as when each version of software of was released.

The lead time may be the sum of a predicted test lead time, a predicted release lead time, and a predicted deployment lead time. The predicted test lead time is the time required to test the above-described past similar mitigation. That is, the predicted test lead time is the time from when the mitigation is applied to the software to when the software with the mitigation applied thereto becomes ready for release. Lead time identifier 142 identifies the predicted test lead time from test tool information c7. The predicted release lead time is the average time required to release the tested software after the completion of the above test. For example, the predicted release lead time is the average time required for the tested software to become downloadable from a server after the completion of the test. The predicted deployment lead time is the time required for the released software to be downloaded from the server to the in-vehicle system in each vehicle and updated. For example, the predicted deployment lead time is the time required for the software to be downloaded to 90% of all the vehicles having the vulnerability and to be updated. In other words, the predicted deployment lead time is the time from software release to the completion of software update. It is to be noted that the above percentage is not limited to 90% and may be any percentage. Lead time identifier 142 identifies the predicted release lead time and the predicted deployment lead time from SIRT-related information c5 and SOC-related information c6.

The deployment method, i.e., the method of uploading the software to the server and installing the software into the in-vehicle system in each vehicle, may be either installation through OTA or installation by a vehicle dealer. The deployment method may be indicated as part of the mitigation in mitigation report a3. Scenario evaluator 140 may determine the details of the deployment method based on the vehicle configuration indicated in TARA information c1 and the above-described predicted deployment lead time.

Impact level identifier 143 may identify predetermined values as impact levels for different cases, such as a case in which a mitigation temporarily disables a single function, and a case in which a problem due to the vulnerability persists even after a mitigation is performed. For this purpose, impact level identifier 143 may derive such a case based on information such as a software backtrace and TARA information c1, and identify the predetermined value for that case as the impact level.

Outputter 160 may cause a display in the vehicle to show the mitigations indicated in mitigation report a3. The display may be a display used for navigation. Outputter 160 may also provide, via the display, a notification for prompting the user to switch between mitigations. For example, mitigation report a3 may indicate a mitigation involving updating or installing software through OTA. If this mitigation would require transmitting a large volume of data through OTA in a poor communication network environment, outputter 160 may provide a notification prompting the user to switch to an alternative mitigation. The alternative mitigation may involve updating or installing the software by a dealer. An example of the poor communication network environment is an environment that only allows communication speeds below a threshold. Thus, if the current mitigation would require transmitting a large volume of data through OTA in a poor communication network environment, the user can switch to an alternative mitigation to smoothly update or install software without delay.

Although vulnerability processing system 100 according to one or more aspects has been described above based on the embodiment, the present disclosure is not limited to the embodiment. Forms obtained by various modifications to the embodiment that can be conceived by a person skilled in the art may be included in the present disclosure as long as the forms do not depart from the essence of the present disclosure.

It should be noted that each of the constituent elements in the foregoing embodiment may be configured in the form of an exclusive hardware product, or may be realized by executing a software program suitable for the constituent element. Each of the constituent elements may be realized by means of a program executing unit, such as a central processing unit (CPU) and a processor, reading and executing the software program recorded on a recording medium such as a hard disk or a semiconductor memory. Here, the software program that realizes, for example, the vulnerability processing system according to the foregoing embodiment is a computer program for causing a computer to execute each of the steps in the flowcharts shown in FIG. 6 and FIG. 7.

It should be noted that the present disclosure also includes the following cases.
(1) At least one of the foregoing system or device is, more specifically, a computer system that includes a microprocessor, a ROM, a RAM, a hard disk unit, a display unit, a keyboard, a mouse, etc. The RAM or the hard disk unit stores the computer program. The microprocessor's operating in accordance with the computer program enables at least one of the foregoing system or device to achieve its function. Here, the computer program is configured, using a combination of a plurality of command codes representing instructions given to the computer to achieve a predetermined function.
(2) One or more, or all of the constituent elements included in at least one of the foregoing system or device may be configured in the form of a single system large scale integration (LSI). The system LSI is a super-multifunctional LSI that is manufactured by integrating a plurality of constituent elements onto a single chip. The RAM stores the computer program. The microprocessor's operating in accordance with the computer program enables the system LSI to achieve its function.
(3) One or more, or all of the elements included in at least one of the foregoing system or device may be implemented in the form of an IC card removable from the device or a single module. The IC card or the module is a computer system that includes a microprocessor, a ROM, a RAM, etc. The IC card or the module may include the foregoing super-multifunctional LSI. The microprocessor's operating in accordance with the computer program enables the IC card or the module to achieve its function. The IC card or the module may be tamper resistant.
(4) The present disclosure may be the method described above. The present disclosure may also be a computer program that enables such a method to be implemented by means of a computer, or digital signals that form a computer program.

The present disclosure may also be configured by means of recording a computer program or digital signals on a computer-readable recording medium such as a flexible disk, a hard disk, a compact (CD)-ROM, a DVD, a DVD-ROM, a DVD-RAM, a Blu-ray (registered trademark) disc (BD), and a semiconductor memory. The present disclosure may also be digital signals recorded on such a recording medium.

The present disclosure may also be configured by means of transmitting the computer program or the digital signals via, for example, a telecommunication line, a wireless or wired communication line, a network represented by the Internet, and data broadcasting.

The present disclosure may also be implemented by means of transmitting the program or the digital signals recorded on a recording medium or transmitting the program or the digital signals via, for example, a network, thereby enabling another independent computer system to carry out the present disclosure.

While various embodiments have been described herein above, it is to be appreciated that various changes in form and detail may be made without departing from the spirit and scope of the present disclosure as presently or hereafter claimed.

### Further Information About Technical Background to This Application

The disclosure of the following patent application including specification, drawings, and claims are incorporated herein by reference in their entirety: Japanese Patent Application No. 2025-055463 filed on Mar. 28, 2025.

### Industrial Applicability

The vulnerability processing system according to the present disclosure is applicable to devices, systems and the like for deriving mitigations against a vulnerability in a system, such as an ECU incorporated in a vehicle.

1. A vulnerability processing system comprising:
a processor; and
memory coupled to the processor,
wherein using the memory, the processor performs:
selecting a plurality of mitigations against a vulnerability;
identifying a lead time of each of the plurality of mitigations;
identifying, for each of the plurality of mitigations, a degree of impact as an impact level, the impact being to be exerted by the mitigation on a system having the vulnerability;
extracting one or more mitigations from the plurality of mitigations by narrowing down the plurality of mitigations, based on the lead time and the impact level that are identified; and
generating a mitigation report indicating the one or more mitigations extracted.

2. The vulnerability processing system according to claim 1,
wherein in the extracting, the processor extracts a temporary mitigation and a drastic mitigation as the one or more mitigations from the plurality of mitigations, the temporary mitigation being a mitigation temporarily taken against the vulnerability, the drastic mitigation being a mitigation drastically taken against the vulnerability.

3. The vulnerability processing system according to claim 2,
wherein in the extracting, the processor extracts a mitigation having the impact level that is less than a threshold value from the plurality of mitigations.

4. The vulnerability processing system according to claim 3,
wherein in the extracting, the processor:
identifies a response priority of the vulnerability;
determines a period based on the response priority as a base period; and
extracts a mitigation having the lead time that falls within the base period from the plurality of mitigations.

5. The vulnerability processing system according to claim 4,
wherein in the extracting, the processor determines the base period that becomes longer as the response priority becomes lower.

6. The vulnerability processing system according to claim 5,
wherein in the extracting, the processor:
determines whether the one or more mitigations extracted include the drastic mitigation; and
when the one or more mitigations extracted do not include the drastic mitigation, extends the base period by decreasing the response priority identified, and performs the narrowing down again using the base period extended.

7. The vulnerability processing system according to claim 1,
wherein the processor further:
obtains information about software as software information by investigating at least one of the vulnerability or a mitigation, the software being to be addressed by a mitigation against the vulnerability; and
includes the software information in the mitigation report in the generating.

8. The vulnerability processing system according to claim 1,
wherein the processor further:
obtains information for identifying a performer as performer information by investigating at least one of the vulnerability or a mitigation, the performer taking a mitigation against the vulnerability; and
includes the performer information in the mitigation report in the generating.

9. The vulnerability processing system according to claim 1,
wherein in the identifying of the lead time, the processor identifies the lead time by referring to dynamic information about the vulnerability updated sequentially.

10. A vulnerability processing method executed by a computer, the vulnerability processing method comprising:
selecting a plurality of mitigations against a vulnerability;
identifying a lead time of each of the plurality of mitigations;
identifying, for each of the plurality of mitigations, a degree of impact as an impact level, the impact being to be exerted by the mitigation on a system having the vulnerability;
extracting one or more mitigations from the plurality of mitigations by narrowing down the plurality of mitigations, based on the lead time and the impact level that are identified; and
generating a mitigation report indicating the one or more mitigations extracted.
